(19) United States
(12) Patent Application Publication
(10) Pub. No.: US 2018/0354455 A1
(43) Pub. Date: Dec. 13, 2018

(54) SEAT BELT RETRIEVAL CONTROL DEVICE

(71) Applicant: KABUSHIKI KAISHA TOKAI-RIKA-DENKI-SEISAKUSHO, Aichi-ken (JP)

(72) Inventors: Tomonari UMAKOSHI, Aichi-ken (JP); Yuya NAGATA, Aichi-ken (JP); Takahiro OSAKI, Aichi-ken (JP); Takuhiro SAITO, Aichi-ken (JP)

(21) Appl. No.: 15/992,284

(22) Filed: May 30, 2018

(30) Foreign Application Priority Data
Jun. 9, 2017 (JP) 2017-114504

(51) Int. Cl. B60R 22/46; B60R 21/013; B60R 21/0132

(52) U.S. Cl. CPC B60R 22/46; B60R 21/013; B60R 2021/01286; B60R 2022/4666; B60R 2021/01317; B60R 21/0132

(57) ABSTRACT

There is provided a seat belt retrieval control device including: a drive unit that drives a retrieval of a webbing; and a setting unit that is configured to, when a vehicle attitude is being controlled by an attitude control unit that controls a vehicle attitude, set a retrieval load applied by the drive unit to a predetermined first load, and when the vehicle attitude is not being controlled by the attitude control unit, set the retrieval load to a second load that is greater than the first load.

### CROSS-REFERENCE TO RELATED APPLICATION

This application is based on and claims priority under 35 USC 119 from Japanese Patent Application No. 2017-114504 filed on Jun. 9, 2017, the disclosure of which is incorporated by reference herein.

### BACKGROUND

### Technical Field

The present disclosure relates to a seat belt retrieval control device that controls webbing retrievals by driving a drive unit such as a motor or the like.

### Related Art

The technology disclosed, for example, in Patent Document 1 has been proposed as a seat belt retrieval device that retrieves webbing using a drive unit such as a motor.

In Japanese Patent Application Laid-Open (JP-A) No. 2009-6747, a seat belt apparatus is proposed that is provided with a belt reel onto which a belt is wound, a motor that drives the belt reel to rotate, a control unit that controls the amount of energization to the motor, and a rotation position detection unit that detects a rotation position of the belt reel.

Specifically, in JP-A No. 2009-6747, the control unit is provided with a device that, when a vehicle is in a predetermined running state, imparts an amount of energization to the motor according to a predetermined constant current, and with a device that, during the period when this energization amount is being imparted to the motor in accordance with the predetermined constant current, if it is determined, based on a rotation position detected by the rotation position detection unit, that the belt reel has reached a predetermined rotation position, imparts an energization amount that maintains this predetermined rotation position.

In JP-A No. 2009-6747, in the predetermined running state, the belt is retrieved so that a vehicle occupant can be restrained. However, if a vehicle stabilization system or the like that controls the vehicle attitude and the like is mounted in a vehicle, any lateral acceleration and the like that is generated in the vehicle occupant varies depending on whether or not control to stabilize the vehicle is being executed. In JP-A No. 2009-6747, no consideration is given as to whether or not such control is being executed, and there is considerable room for improvement in this regard.

### SUMMARY

The present disclosure was conceived in view of the above-described circumstances and the present disclosure provides a seat belt retrieval control device capable of retrieving a webbing at an appropriate retrieval load that matches the vehicle's situation.

In order to achieve the above-described object, a first aspect is provided with a drive unit that drives a retrieval of a webbing, and a setting unit that, when a vehicle attitude is being controlled by an attitude control unit that controls a vehicle attitude, sets a retrieval load applied by the drive unit to a predetermined first load, and when the vehicle attitude is not being controlled by the attitude control unit, sets the retrieval load to a second load that is greater than the first load.

According to the first aspect, a webbing is retrieved by driving the drive unit.

When the vehicle attitude is being controlled by the attitude control unit that controls the vehicle attitude, the setting unit sets the retrieval load applied by the drive unit to a predetermined first load. In contrast, when the vehicle attitude is not being controlled by the attitude control unit, the setting unit sets the retrieval load to a second load that is greater than the first load.

As a consequence, because webbing is retrieved at a first load when vehicle attitude control is being performed, while the webbing is retrieved at a second load which is greater than the first load when vehicle attitude control is not being performed, a webbing can be retrieved at an appropriate retrieval load that matches the vehicle's situation.

A second aspect is provided with a drive unit that drives a retrieval of a webbing, and a setting unit that, when a switching state of a switch unit that switches between whether control is to be performed or is not to be performed by the attitude control unit that controls the vehicle attitude is in a state in which control is being performed by the attitude control unit, sets the retrieval load applied by the drive unit to the predetermined first load, and when the switching state of the switch unit is in a state in which control is not being performed by the attitude control unit, sets the retrieval load to the second load that is greater than the first load.

According to the second aspect, a webbing is retrieved by driving the drive unit.

When the switching state of the switch unit that switches between whether or not control is to be performed by the attitude control unit that controls the vehicle attitude is in a state in which control is being performed by the attitude control unit, the setting unit sets the retrieval load applied by the drive unit to the predetermined first load. In contrast, when the switching state of the switch unit is in a state in which control is not being performed by the attitude control unit, the setting unit sets the retrieval load to the second load that is greater than the first load.

As a consequence, because webbing is retrieved at a first load when vehicle attitude control is being performed, while the webbing is retrieved at a second load which is greater than the first load when vehicle attitude control is not being performed, a webbing can be retrieved at an appropriate retrieval load that matches the vehicle's situation.

Note that it is also possible for the setting unit to additionally perform retrieval control in order to retrieve the webbing by applying a set retrieval load when a collision is predicted by a collision prediction unit that predicts a vehicle collision.

Additionally, it is also possible for the setting unit to set the retrieval load when a lateral slip of a vehicle is detected by a lateral slip detection unit that detects a vehicle lateral slip.

Furthermore, it is also possible for the first load to be a load in which the retrieval load rises more gradually than in the second load.

As is described above, according to the present disclosure, the effect is obtained that it is possible to provide a seat belt retrieval control device capable of retrieving a webbing at an appropriate retrieval load that matches the vehicle's situation.

### BRIEF DESCRIPTION OF THE DRAWINGS

Exemplary embodiments of the present disclosure will be described in detail based on the following figures, wherein:

FIG. 1 is a front view showing a schematic structure of a seat belt apparatus that is to be controlled by a seat belt retrieval control device according to the present exemplary embodiment;

FIG. 2 is a block diagram showing the structure of the seat belt retrieval control device according to the first exemplary embodiment;

FIG. 3A is a view showing an example of webbing retrieval loads;

FIG. 3B is a view showing an example of webbing retrieval loads in which the load rise of a low load is more gentle than that of a high load;

FIG. 4 is a flowchart showing an example of a flow of processing performed by a control unit of the seat belt retrieval control device according to the first exemplary embodiment;

FIG. 5 is a block diagram showing the structure of a seat belt retrieval control device according to a second exemplary embodiment;

FIG. 6 is a flowchart showing an example of a flow of processing performed by a control unit of the seat belt retrieval control device according to the second exemplary embodiment;

FIG. 7 is a block diagram showing the structure of a seat belt retrieval control device of a variant example; and

FIG. 8 is a flowchart showing an example of a flow of processing performed by a control unit of the seat belt retrieval control device of the variant example.

### DETAILED DESCRIPTION

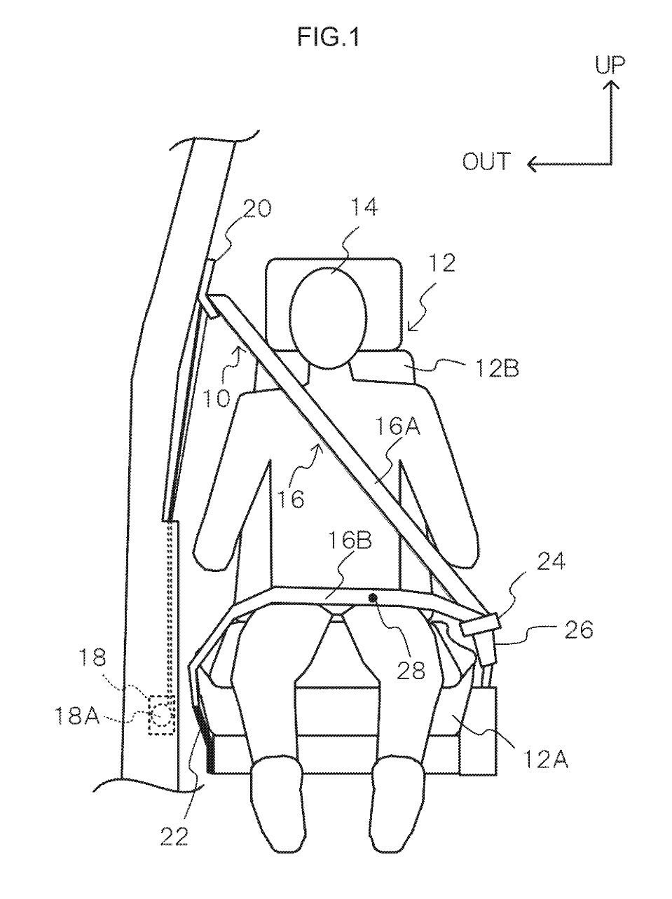

Hereinafter, examples of exemplary embodiments of the present disclosure will be described in detail with reference to the drawings. FIG. 1 is a front view showing a schematic structure of a seat belt apparatus that is to be controlled by a seat belt retrieval control device according to the present exemplary embodiment. Note that in FIG. 1, an outward side (i.e., a vehicle right-side) in a vehicle width direction is shown by an arrow OUT, while an upward direction is shown by an arrow UP.

As is shown in FIG. 1, a seat belt apparatus 10 is mounted on a seat 12 of a vehicle, and a front side, a right side, and an upper side of the seat 12 face respectively towards a front side, a right side, and an upper side of the vehicle. A seat cushion 12A is provided at a lower portion of the seat 12, and a seat back 12B is provided at a rear portion of the seat 12, so that an occupant 14 of the vehicle is able to sit in the seat 12.

The seat belt apparatus 10 is provided with an elongated belt-shaped webbing 16 (i.e., a belt) which is flexible.

The webbing 16 is retrieved from a base end side in the longitudinal direction thereof into a retrieval device 18 and is stored in this retrieval device 18. The retrieval device 18 is fixed to the vehicle body (or to the seat 12 itself) at a lower portion on an outer side in the vehicle width direction of the seat 12, and the webbing 16 is pulled out towards the vehicle front side.

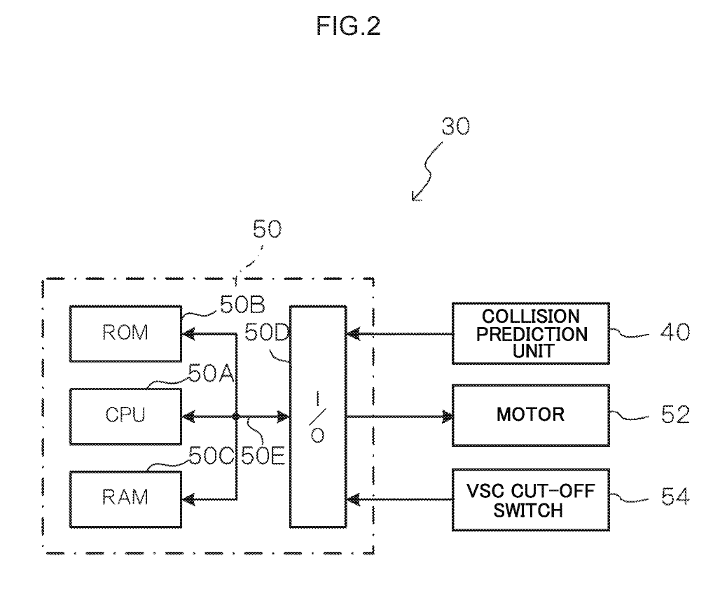

A locking mechanism (not shown in the drawings) is provided in the retrieval device 18, and in the event of a vehicle emergency such as when the vehicle is in a collision (i.e., when the webbing 16 is abruptly pulled out from the retrieval device 18, or when the vehicle suddenly decelerates), the locking mechanism is operated and the pulling out of the webbing 16 from the retrieval device 18 is locked. Additionally, a motor 52 (see FIG. 2) serving as an example of a drive unit is provided in the retrieval device 18, and the retrieval of the webbing 16 onto a spool 18A is made possible by the driving of the motor 52.

A shoulder anchor 20 is fixed to the vehicle body (or to the seat 12 itself) on the vehicle rear side at an upper portion on an outer side in the vehicle width direction of the seat 12, and an elongated, rectangular insertion hole is formed penetrating the shoulder anchor 20.

The webbing 16 is inserted through the insertion hole in the shoulder anchor 20, and the webbing 16 is then folded over at the insertion hole in the shoulder anchor 20 and is supported in this state.

A distal end in the longitudinal direction of the webbing 16 is supported by an anchor 22, and the anchor 22 is fixed to the vehicle body (or to the seat 12 itself) on a lower side on an outer side in the vehicle width direction of the rear portion of the seat 12.

A tongue 24 is provided on a portion of the webbing between the shoulder anchor 20 and the anchor 22. An elongated, rectangular insertion hole is formed penetrating the tongue 24, and the webbing 16 is inserted through this insertion hole in such a way that the webbing 16 is able to move freely in the longitudinal direction thereof.

Moreover, a buckle 26 is fixed to the vehicle body (or to the seat 12 itself) at the lower side on the inner side in the vehicle width direction of the rear portion of the seat 12. The tongue 24 is removably inserted into the buckle 26, and by pulling the webbing 26 out from the retrieval device 18 and inserting the tongue 24 into the buckle 26, the webbing 16 is fitted from the front over the occupant 14 seated in the seat 12.

Consequently, as a result of the webbing 16 being folded over at the insertion hole in the tongue 24 and being supported in this state, the portion of the webbing 16 between the shoulder anchor 20 and the tongue 24 (i.e., the portion on one side of the tongue 24) is formed as a shoulder webbing 16A (i.e., a shoulder belt), and is fitted in a sloping direction over the shoulder portion and chest portion of the occupant 14.

Additionally, the portion of the webbing 16 between the tongue 24 and the anchor 22 (i.e., the portion on the other side of the tongue 24) is formed as a lap webbing 16B (i.e., a lap belt), and is fitted in a horizontal direction over the waist portion of the occupant 14.

Note that a tongue stopper 28 that protrudes from both surfaces of the lap webbing 16B is attached to the lap webbing 16B, and movement of the tongue 24 towards the distal end side in the longitudinal direction of the webbing 16 is restricted by this tongue stopper 28.

### First Exemplary Embodiment

Next, a structure of a seat belt retrieval control device according to a first exemplary embodiment will be described. FIG. 2 is a block diagram showing the structure of the seat belt retrieval control device according to the first exemplary embodiment.

The seat belt retrieval control device 30 is provided with a control unit 50 which serves as an example of a setting unit that controls the driving of the motor 52 that performs the retrieval of the webbing 16.

The control unit 50 is formed by a computer in which a CPU 50A, ROM 50B, RAM 50C, and an I/O (i.e., an input/output interface) 50D are connected to a bus 50E.

A program that controls the retrieval of the webbing 16 of the seat belt apparatus 10 is stored in the ROM 50B. Retrieval control of the webbing 16 is performed as a result of the program stored in the ROM 50B being expanded in the RAM 50C and then executed by the CPU 50A.

The motor 52 is connected to the I/O 50D, and a collision prediction unit 40 and a VSC (Vehicle Stability Control) cut-off switch 54 are also connected thereto.

As is described above, the motor 52 performs the retrieval of the webbing 16 onto the spool 18A. Specifically, by driving the spool 18A onto which the webbing 16 is retrieved such that this spool 18A is rotated, the webbing 16 is retrieved onto the spool 18A.

The collision prediction unit 40 predicts a vehicle collision by employing known technology, and outputs prediction results to the control unit 50. The collision prediction unit 40 monitors the area around a vehicle using, for example, images captured using various types of radars, sensors, and cameras and the like, and then predicts any collision with the vehicle, or any collision with an obstacle or the like.

The VSC cut-off switch 54 is a switch that is used to turn on and off operations of a VSC control unit which is serving as an attitude control unit. By turning on the VSC cut-off switch 54, the control being performed by the VSC control unit is canceled, and by turning off this VSC cut-off switch 54, the control to be performed by the VSC control unit is performed. In the present exemplary embodiment, the state of the VSC cut-off switch 54 is input into the control unit 50,

Here, the retrieval control of the webbing 16 performed by the control unit 50 of the seat belt retrieval control device 30 according to the present exemplary embodiment will be described.

When the collision prediction unit 40 predicts that the vehicle will be in a collision, the seat belt retrieval control device 30 according to the present exemplary embodiment drives the motor 52 before the collision occurs so as to retrieve the webbing 16. As a result, what is known as PSB (Pre-crash Seat Belt) control which restrains the vehicle occupant is performed.

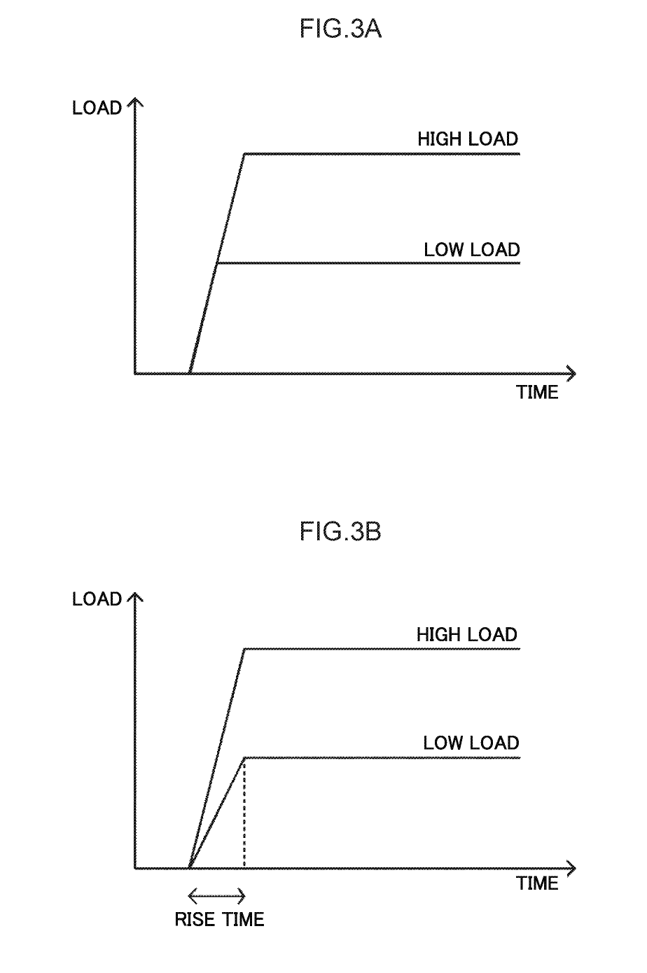

Moreover, in the present exemplary embodiment, when driving the motor 52 using PSB control, control to alter the retrieval load applied to the webbing 16 is also performed. Specifically, the control unit 50 acquires the state of the VSC cut-off switch 54 and, in accordance with the state of the VSC cut-off switch 54, performs control to alter the retrieval load applied to the webbing 16. In the present exemplary embodiment, the retrieval load applied to the webbing 16 is altered by altering the amount of energization imparted to the motor 52. In the present exemplary embodiment, as is shown in FIG. 3A, the load applied to retrieve the webbing 16 can be altered to a predetermined high load which is serving as a second load, or to a predetermined low load which is serving as a first load.

When the VSC cut-off switch 54 is turned off, the vehicle is stabilized via the control performed by the VSC control unit. In contrast, when the VSC cut-off switch 54 is turned on, the vehicle is not stable due to control not being performed by the VSC control unit. Because of this, the lateral acceleration generated in the vehicle differs depending on whether the VSC cut-off switch 54 is on or off, and the load required for the seat belt restraint also differs. Therefore, in the present exemplary embodiment, when the VSC cut-off switch 54 is turned off, the retrieval load applied to the webbing 16 is set to the low load, and when the VSC cut-off switch 54 is turned on, the retrieval load applied to the webbing 16 is set to the high load.

Note that the load rise is different when the load is a high load from when the load is a low load, and, as is shown in FIG. 3B, the rise in the load in the case of a low load is more gentle than in the case of a high load. By doing this, the vehicle occupant does not become startled, and any obstruction to the movement of the vehicle occupant is suppressed.

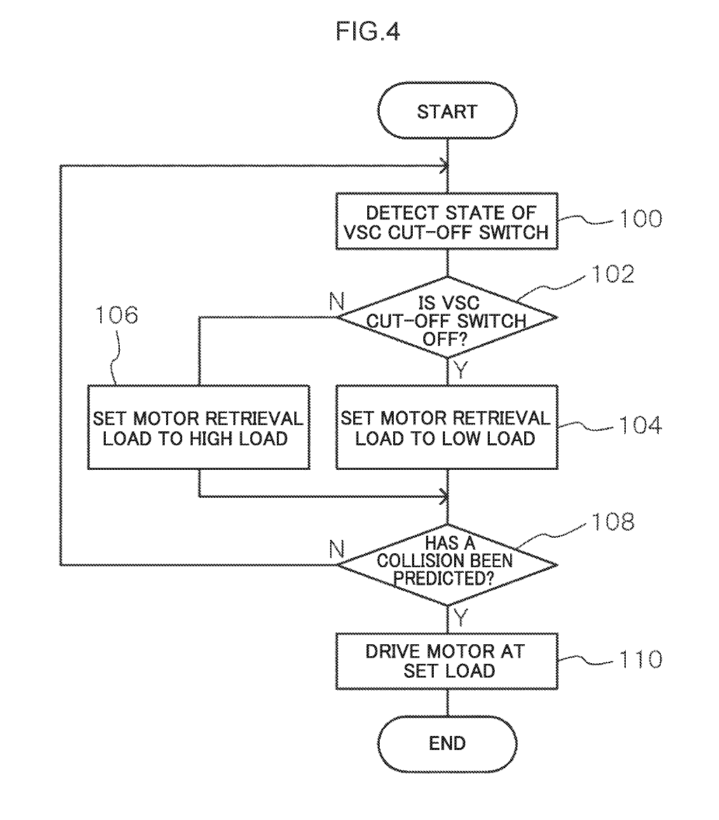

Next, the specific processing performed by the control unit 50 of the seat belt retrieval control device 30 according to the present exemplary embodiment having the above-described structure will be described. FIG. 4 is a flowchart showing an example of a flow of processing performed by the control unit 50 of the seat belt retrieval control device 30 according to the present exemplary embodiment. Note that the processing shown in FIG. 4 commences when an ignition switch (not shown in the drawings) has been turned on, and it is detected that a vehicle occupant is wearing their seat belt (i.e., that the tongue 24 has been inserted into the buckle 26).

In step 100, the CPU 50A detects the state of the VSC cut-off switch 54, and the routine moves to step 102.

In step 102, the CPU 50A determines whether or not the VSC cut-off switch 54 is turned off, and if this determination is affirmative, the routine moves to step 104. If, however, the determination is negative, the routine moves to step 106.

In step 104, the CPU 50A sets the retrieval load of the motor 52 to the low load, and the routine then moves to step 108. As a result, when a collision is predicted by the collision prediction unit 40 and the webbing 16 is accordingly retrieved, the retrieval of the webbing 16 is performed at a low load.

In contrast, in step 106, the CPU 50A sets the retrieval load of the motor 52 to the high load, and the routine then moves to step 108. As a result, when a collision is predicted by the collision prediction unit 40 and the webbing 16 is accordingly retrieved, the retrieval of the webbing 16 is performed at a high load.

In step 108, the CPU 50A determines whether or not a collision has been predicted by the collision prediction unit 40, and if this determination is negative, the routine returns to step 100 and the above-described processing is repeated. If, however, the determination is affirmative, the routine moves to step 110.

In step 110, the CPU 50A drives the motor 52 at the load set in step 104 or the load set in step 106, and the processing sequence is ended. In other words, the webbing 16 is retrieved at the low load if the VSC cut-off switch 54 is turned off, and the webbing 16 is retrieved at the high load if the VSC cut-off switch 54 is turned on.

In this way, by altering the retrieval load applied to the webbing 16 in accordance with the state of the VSC cut-off switch 54, a vehicle occupant can be properly restrained without any complex sensors needing to be employed.

### Second Exemplary Embodiment

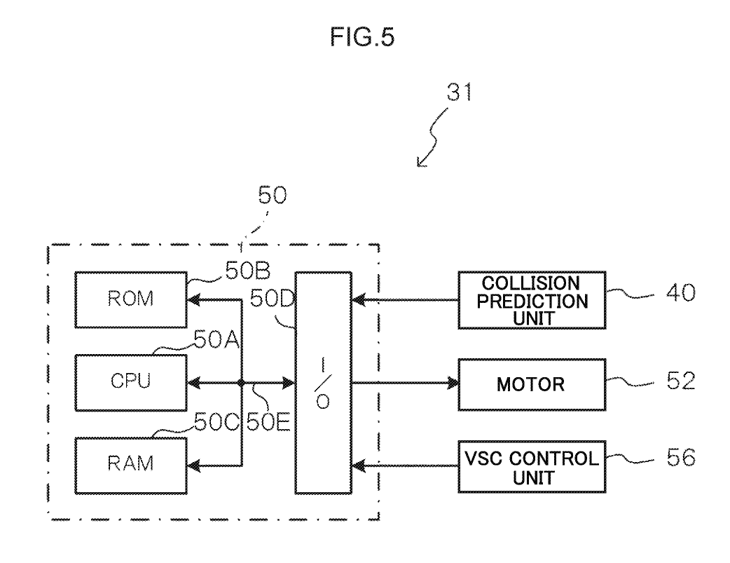

Next, a structure of a seat belt retrieval control device according to a second exemplary embodiment will be described. FIG. 5 is a block diagram showing the structure of the seat belt retrieval control device according to the second exemplary embodiment.

In the first exemplary embodiment, the setting of the retrieval load applied to the webbing 16 is altered in accordance with the state of the VSC cut-off switch 54, however, in a seat belt retrieval control device 31 according to the present exemplary embodiment, the retrieval load is altered in accordance with whether or not control is being executed by a VSC control unit 56.

In other words, as is shown in FIG. 5, the seat belt retrieval control device 31 according to the present exemplary embodiment differs from the first exemplary embodiment in that, instead of the VSC cut-off switch 54, a VSC control unit 56 which serves as an attitude control unit is connected to the control unit 50. Because the remaining structure is the same, a detailed description thereof is omitted.

In accordance with an acquisition request or the like from the control unit 50, the VSC control unit 56 notifies the control unit 50 as to whether or not VSC control to stabilize the vehicle is being executed. Alternatively, it is also possible to employ a format in which the VSC control unit 56 outputs a control signal when VSC control is being executed, and does not output a control signal when VSC control is not being executed.

In accordance with the notification from the VSC control unit 56 as to whether or not VSC control is being executed, the control unit 50 alters the setting of the retrieval load applied to the webbing 16. Specifically, when VSC control is being executed, the retrieval load is set to the low load, and when VSC control is not being executed, the retrieval load is set to the high load.

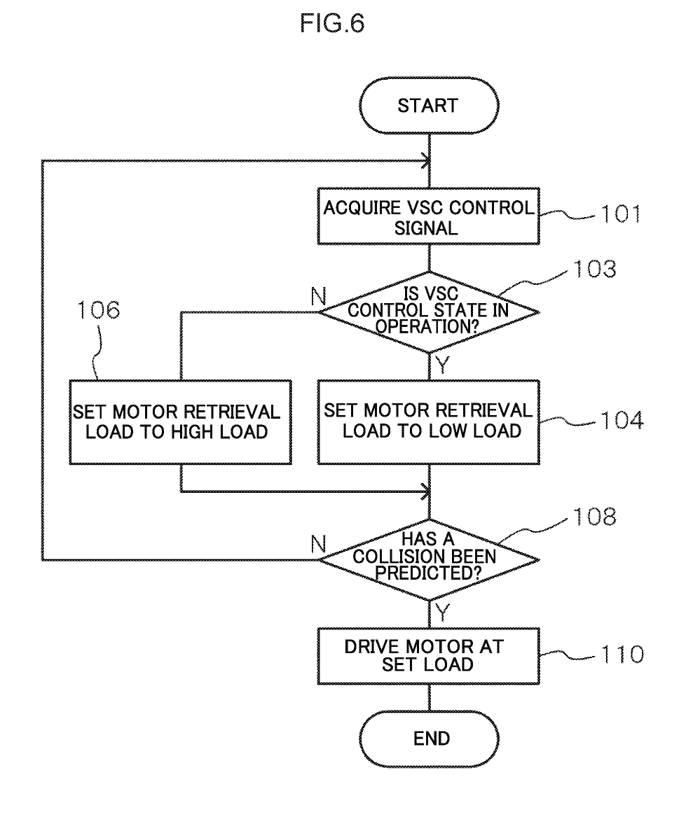

Next, the specific processing performed by the control unit 50 of the seat belt retrieval control device 31 according to the present exemplary embodiment will be described. FIG. 6 is a flowchart showing an example of a flow of processing performed by the control unit 50 of the seat belt retrieval control device 31 according to the present exemplary embodiment. Note that the processing shown in FIG. 6 commences when an ignition switch (not shown in the drawings) has been turned on, and it is detected that a vehicle occupant is wearing their seat belt (i.e., that the tongue 24 has been inserted into the buckle 26). Note also that any processing that is the same as the processing in FIG. 4 is described using the same descriptive symbols.

In step 101, the CPU 50A acquires a VSC control signal from the VSC control unit 56, and the routine moves to step 103.

In step 103, the CPU 50A determines whether or not a VSC control state implemented by the VSC control unit 56 is currently in operation, and if this determination is affirmative, the routine moves to step 104. If, however, the determination is negative, the routine moves to step 106.

In step 104, the CPU 50A sets the retrieval load of the motor 52 to the low load, and the routine then moves to step 108. As a result, when a collision is predicted by the collision prediction unit 40 and the webbing 16 is accordingly retrieved, the retrieval of the webbing 16 is performed at a high load.

In contrast, in step 106, the CPU 50A sets the retrieval load of the motor 52 to the high load, and the routine then moves to step 108. As a result, when a collision is predicted by the collision prediction unit 40 and the webbing 16 is accordingly retrieved, the retrieval of the webbing 16 is performed at a low load.

In step 108, the CPU 50A determines whether or not a collision has been predicted by the collision prediction unit 40, and if this determination is negative, the routine returns to step 101 and the above-described processing is repeated. If, however, the determination is affirmative, the routine moves to step 110.

In step 110, the CPU 50A drives the motor 52 at the load set in step 104 or the load set in step 106, and the processing sequence is ended. In other words, the webbing 16 is retrieved at the low load if VSC control is being executed by the VSC control unit 56, and the webbing 16 is retrieved at the high load if VSC control is not being executed by the VSC control unit 56.

In this way, even when the control state implemented by the VSC control unit 56 is detected directly, and the retrieval load applied to the webbing 16 is altered in accordance with this control state, a vehicle occupant can be properly restrained without any complex sensors needing to be employed.

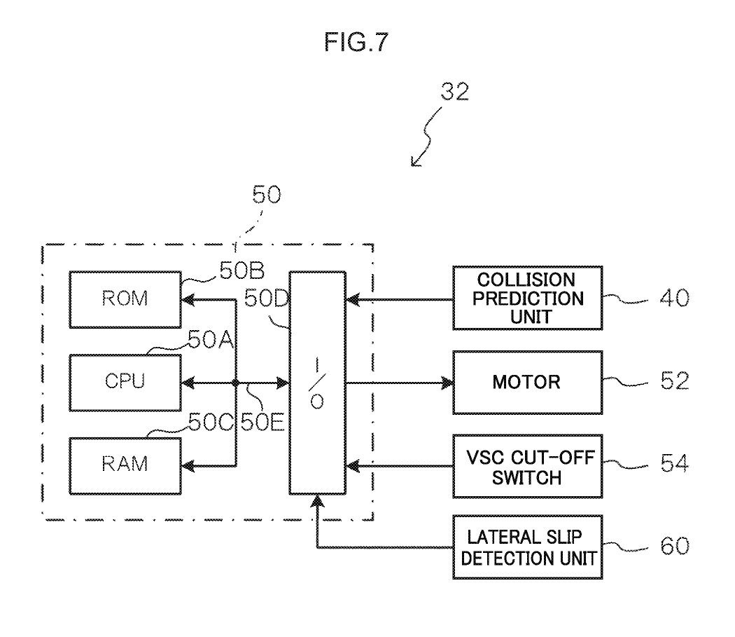

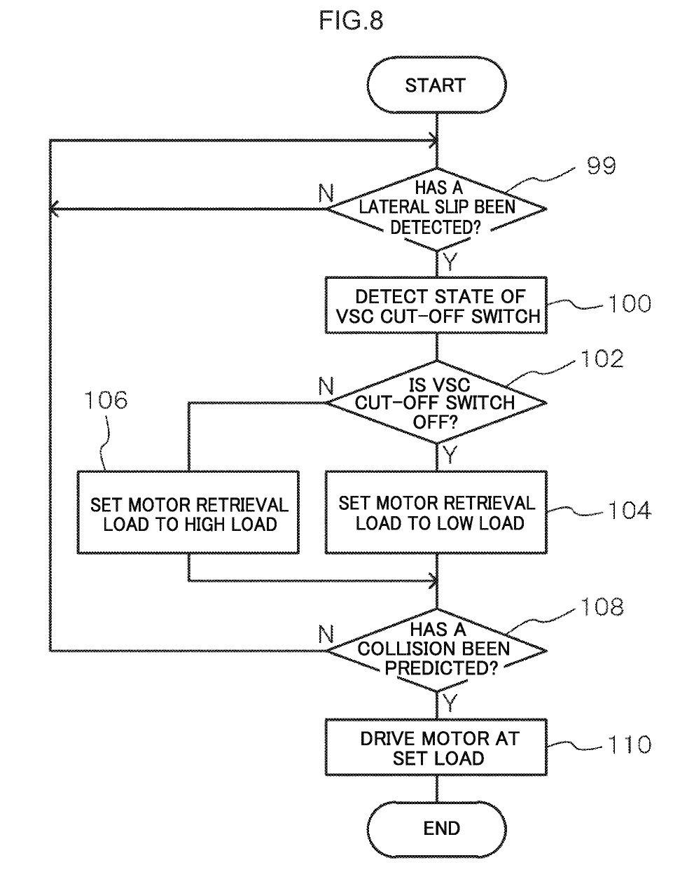

Note that the processing performed by the control unit 50 in the above-described exemplary embodiment may also be performed when the vehicle experiences a lateral slip. FIG. 7 is a block diagram showing the structure of a seat belt retrieval control device 32 of a variant example. Namely, in the seat belt retrieval control device 32 of the variant example shown in FIG. 7, a lateral slip detection unit 60 is additionally connected to the control unit 50 of the first exemplary embodiment. The lateral slip detection unit 60 detects a lateral slip of a vehicle, and outputs its detection results to the control unit 50. For example, the lateral slip detection unit 60 detects a lateral slip by acquiring signals from a steering angle sensor, a vehicle speed sensor, and a yaw rate sensor. The lateral slip detection method employed may be one in which it is determined that a lateral slip has occurred when, for example, there is a discrepancy between the turning speed that the driver's steering intended and which is estimated from the steering angle sensor and the vehicle speed sensor, and the actual turning speed detected by the yaw rate sensor. The setting of the retrieval load applied to the webbing 16 by the control unit 50 is triggered when a lateral slip is detected by the lateral slip detection unit 60. In other words, if a lateral slip occurs, the retrieval load applied to the webbing 16 is set to a high load or to a low load in accordance with the state of the VSC cut-off switch 54. As is shown in FIG. 8, the processing in this case may, for example, be added to the processing shown in FIG. 4 in the form of the processing content of a step 99. In other words, in step 99, the CPU 50A determines from the detection results from the lateral slip detection unit 60 whether or not a lateral slip has been detected. The CPU 50A remains on standby until this determination is affirmative, and when the determination does become affirmative, the routine moves to step 100. Note that, in the same way as is shown in FIG. 7, it is also possible to employ a structure in which the lateral slip detection unit 60 is additionally connected to the control unit 50 in the seat belt retrieval control device 31 according to the second exemplary embodiment.

Moreover, the processing performed by the control unit 50 in the above-described exemplary embodiments is described as being processing performed by software, however, the present disclosure is not limited to this. For example, it is also possible for the processing to be performed by hardware, or for the processing to be performed by a combination of both hardware and software.

Additionally, the processing performed by the control unit 50 in the above-described exemplary embodiments may also be stored as a program on a storage medium, and then distributed.

Furthermore, it should be understood that the present disclosure is not limited to the foregoing description, and various modifications and the like may be made thereto insofar as they do not depart from the spirit or scope of the present disclosure.

What is claimed is:

1. A seat belt retrieval control device comprising:
a drive unit that drives a retrieval of a webbing; and
a setting unit that is configured to, when a vehicle attitude is being controlled by an attitude control unit that controls a vehicle attitude, set a retrieval load applied by the drive unit to a predetermined first load, and when the vehicle attitude is not being controlled by the attitude control unit, set the retrieval load to a second load that is greater than the first load.

2. A seat belt retrieval control device comprising:
a drive unit that drives a retrieval of a webbing; and
a setting unit that is configured to, when a switching state of a switch unit that switches between whether control is to be performed or is not to be performed by the attitude control unit that controls the vehicle attitude is in a state in which control is being performed by the attitude control unit, set the retrieval load applied by the drive unit to the predetermined first load, and when the switching state of the switch unit is in a state in which control is not being performed by the attitude control unit, set the retrieval load to the second load that is greater than the first load.

3. The seat belt retrieval control device according to claim 1, wherein the setting unit is configured to additionally perform retrieval control in order to retrieve the webbing at a set retrieval load when a collision is predicted by a collision prediction unit that predicts a vehicle collision.

4. The seat belt retrieval control device according to claim 2, wherein the setting unit is configured to additionally perform retrieval control in order to retrieve the webbing at a set retrieval load when a collision is predicted by a collision prediction unit that predicts a vehicle collision.

5. The seat belt retrieval control device according to claim 1, wherein the setting unit is configured to set the retrieval load when a lateral slip of a vehicle is detected by a lateral slip detection unit that detects a vehicle lateral slip.

6. The seat belt retrieval control device according to claim 2, wherein the setting unit is configured to set the retrieval load when a lateral slip of a vehicle is detected by a lateral slip detection unit that detects a vehicle lateral slip.

7. The seat belt retrieval control device according to claim 1, wherein, in the first load, the retrieval load rises more gradually than in the second load.

8. The seat belt retrieval control device according to claim 2, wherein, in the first load, the retrieval load rises more gradually than in the second load.
